(19) United States
(12) Patent Application Publication
(10) Pub. No.: US 2024/0086962 A1
(43) Pub. Date: Mar. 14, 2024

(54) SYSTEM, AUTHENTICATION SERVER, MANAGEMENT SERVER, AUTHENTICATION TERMINAL AND METHOD

(71) Applicant: NEC Corporation, Minato-ku, Tokyo (JP)

(72) Inventor: Hidenori Kitakata, Tokyo (JP)

(73) Assignee: NEC Corporation, Minato-ku, Tokyo (JP)

(21) Appl. No.: 18/275,131

(22) PCT Filed: Feb. 4, 2021
(86) PCT No.: PCT/JP2021/004084

§ 371 Date: Jul. 31, 2023

(51) Int. Cl. G06Q 30/0207; G06Q 20/40

(52) U.S. Cl. CPC G06Q 30/0225; G06Q 20/40145

(57) ABSTRACT

Authentication server stores biometric information and a user ID of each of a plurality of users in association with each other. Management server stores the user ID of each of the plurality of users and information of electronic coupons owned by each user in association with each other. Authentication terminal transmits authentication request including biometric information of first user who uses the electronic coupon among the plurality of users to the authentication server. The authentication server identifies first user ID corresponding to the first user by a biometric authentication using the biometric information included in the authentication request, and transmits coupon information transmission instruction including the identified first user ID to the management server. The management server transmits owned coupon information related to the electronic coupon owned by the first user corresponding to the first user ID included in the coupon information transmission instruction to the authentication terminal.

### TECHNICAL FIELD

This invention relates to a system, an authentication server, a management server, an authentication terminal, and a method.

### BACKGROUND ART

There are systems that handle coupons held by consumers and so on.

For example, Patent Literature 1 describes a system in which a store terminal reads a coupon displayed on a user terminal when settling payment for a product, so that a burden on the store can be reduced. A benefit provision device of Patent Literature 1 includes a payment token request receiving unit, a token generation unit, a token transmission unit, a payment request receiving unit, a validity determination unit, and a benefit provision unit. The payment token request receiving unit receives a token request including user identification information from the user terminal. The token generation unit generates a token associated with coupon identification information and the user identification information. The token transmission unit transmits the token to the user terminal. The payment request receiving unit receives the payment request including the token from the store terminal. The validity determination unit determines whether the coupon associated with the coupon identification information is valid or not. When the validity determination unit determines that the coupon is valid, the benefit provision unit provides the user with the benefit provided by the coupon associated with the coupon identification information corresponding to the token.

Patent Literature 2 describes simplifying payments at a physical store. An information processing device of Patent Literature 2 includes an association unit, an acquisition unit, a selection unit, and a calculation unit. The association unit associates a user ID with coupon information according to a request from the user terminal. The acquisition unit acquires the user ID, a store ID, and an amount spent from either the user terminal or a store terminal. The selection unit selects coupon information applicable to the amount spent acquired by the acquisition unit based on the user ID and the store ID. The calculation unit calculates a settlement amount by applying the coupon information selected by the selection unit to the amount spent.

### CITATION LIST

### Patent Literature

[PTL 1] Japanese Unexamined Patent Application Publication No. 2020-155125
[PTL 2] Japanese Unexamined Patent Application Publication No. 2020-004386

### SUMMARY OF INVENTION

### Technical Problem

Coupons are issued for various purposes. For example, in addition to coupons issued by retailers for sales promotion, local governments and so on may issue (sell) coupons for a purpose of reconstructing of the local economy. A user often purchases a plurality of coupons, in which case managing the coupons owned by the user becomes a burden.

It is a main object of the present invention to provide a system, an authentication server, a management server, an authentication terminal, and a method that contribute to reducing a burden on a coupon purchaser.

### Solution to Problem

According to a first aspect of the present invention, there is provided a system, including: an authentication server that stores biometric information and a user ID of each of a plurality of users in association with each other; a management server, the management server being connected to the authentication server, that stores the user ID of each of the plurality of users and information of at least one or more electronic coupons owned by each user in association with each other; and an authentication terminal that is connected to the authentication server and the management server, wherein the authentication terminal transmits an authentication request including biometric information of a first user who uses the electronic coupon among the plurality of users to the authentication server, wherein the authentication server identifies a first user ID corresponding to the first user by a biometric authentication using the biometric information included in the authentication request, and transmits a coupon information transmission instruction including the identified first user ID to the management server, and wherein the management server transmits owned coupon information related to the electronic coupon owned by the first user corresponding to the first user ID included in the coupon information transmission instruction to the authentication terminal.

According to a second aspect of the present invention, there is provided an authentication server including: a database that stores biometric information and a user ID of each of a plurality of users in association with each other, a receiving unit that receives an authentication request including biometric information of a first user who uses an electronic coupon among the plurality of users from an authentication terminal; an authentication unit that identifies a first user ID corresponding to the first user by biometric authentication using biometric information included in the authentication request; and a transmission unit that transmits a coupon information transmission instruction including the identified first user ID to a management server that stores the user ID of each of the plurality of users and information of at least one or more electronic coupons owned by each user in association with each other.

According to a third aspect of the present invention, there is provided a control server including: a database that stores a user ID of each of a plurality of users and information of at least one or more electronic coupons owned by each user in association with each other; a receiving unit that receives a coupon information transmission instruction from an authentication server that stores biometric information and the user ID of each of the plurality of the users in association with each other, receives an authentication request including the biometric information of a first user who uses the electronic coupon among the plurality of users from an authentication terminal, identifies a first user ID corresponding to the first user by the biometric authentication by using the biometric information included in the authentication request, and transmits the coupon information transmission request including the identified first user ID; and a transmission unit that transmits owned coupon information related to the electronic coupon that is owned by the first user corresponding to the first user ID included in the coupon information transmission instruction to the authentication terminal.

According to a fourth aspect of the present invention, there is provided an authentication terminal including: a transmission unit that transmits an authentication request including biometric information of a first user who uses an electronic coupon among a plurality of users to an authentication server that stores biometric information and a user ID of each of the plurality of users in association with each other; and a receiving unit that receives owned coupon information related to an electronic coupon owned by the first user corresponding to a first user ID included in a coupon information transmission instruction from a management server that stores the user ID of each of the plurality of users and information of at least one or more electronic coupons owned by each user in association with each other, and receives a coupon information transmission instruction including the first user ID corresponding to the first user from the authentication server.

According to a fifth aspect of the present invention, there is provided a method including: an authentication server that stores biometric information and a user ID of each of a plurality of users in association with each other; a management server, being connected to the authentication server, that stores the user ID of each of the plurality of users and information of at least one or more electronic coupons owned by each user in association with each other; and an authentication terminal that is connected to the authentication server and the management server; wherein the method including: transmitting an authentication request including biometric information of a first user who uses the electronic coupon among the plurality of users to the authentication server; identifying a first user ID corresponding to the first user by the biometric authentication using the biometric information included in the authentication request and transmitting a coupon information transmission instruction including the identified first user ID to the management server; and transmitting owned coupon information related to the electronic coupon owned by the first user corresponding to the first user ID included in the coupon information transmission instruction to the authentication terminal.

### Advantageous Effects of Invention

According to the individual aspects of the present invention, there are provided a system, an authentication server, a management server, an authentication terminal, and a method that contribute to reducing a burden on coupon purchasers. The advantageous effect of the present invention is not limited to the above advantageous effect. The present invention may provide other advantageous effects, instead of or in addition to the above advantageous effect.

### BRIEF DESCRIPTION OF THE DRAWINGS

FIG. 1 is a diagram illustrating an outline of an example embodiment.

FIG. 2 is a diagram illustrating an example of a schematic configuration of an information processing system according to a first example embodiment.

FIG. 3 is a diagram illustrating a schematic operation of an information processing system according to the first example embodiment.

FIG. 4 is a diagram illustrating a schematic operation of an information processing system according to the first example embodiment.

FIG. 5 is a diagram illustrating a schematic operation of an information processing system according to the first example embodiment.

FIG. 6 is a diagram illustrating an example of a processing configuration of an authentication server according to the first example embodiment.

FIG. 7 is a diagram illustrating an example of a user information database according to the first example embodiment.

FIG. 8 is a diagram illustrating an example of a processing configuration of a management server according to the first example embodiment.

FIG. 9 is a diagram illustrating an operation of a coupon sales unit according to the first example embodiment.

FIG. 10 is a diagram illustrating an example of a coupon detailed information database according to the first example embodiment.

FIG. 11 is a diagram illustrating an example of a coupon management database according to the first example embodiment.

FIG. 12 is a diagram illustrating an example of a processing configuration of an authentication terminal according to the first example embodiment.

FIG. 13 is a diagram illustrating an operation of a coupon usage unit according to the first example embodiment.

FIG. 14 is a diagram illustrating an example of a processing configuration of a terminal according to the first example embodiment.

FIG. 15 is a diagram illustrating an operation of a user registration request unit according to the first example embodiment.

FIG. 16 is a sequence diagram illustrating an example of an operation of an information processing system according to the first example embodiment.

FIG. 17 is a diagram illustrating an example of a schematic configuration of an information processing system according to a second example embodiment.

FIG. 18 is a diagram illustrating an example of a processing configuration of a terminal according to the second example embodiment.

FIG. 19 is a diagram illustrating an example of a processing configuration of an authentication server according to the second example embodiment.

FIG. 20 is a diagram illustrating an example of a paper coupon according to the second example embodiment.

FIG. 21 is a diagram illustrating an operation of a coupon registration request unit according to the second example embodiment.

FIG. 22 is a diagram illustrating an operation of a terminal according to the second example embodiment.

FIG. 23 is a diagram illustrating an example of a user information database according to the second example embodiment.

FIG. 24 is a sequence diagram illustrating an example of an operation of an information processing system according to the second example embodiment.

FIG. 25 is a diagram illustrating an operation of a coupon registration request unit in a variation according to the second example embodiment.

FIG. 26 is a diagram illustrating an example of a hardware configuration of an authentication server of the present application.

### EXAMPLE EMBODIMENT

First, an outline of an example embodiment will be described. In the following outline, various components are denoted by reference characters for the sake of convenience. That is, the following reference characters are used as examples to facilitate the understanding of the present invention. Thus, the description of the outline is not intended to impose any limitations. In addition, unless otherwise specified, an individual block illustrated in the drawings represents a configuration of a functional unit, not a hardware unit. An individual connection line between blocks in the drawings signifies both one-way and two-way directions. An arrow schematically illustrates a principal signal (data) flow and does not exclude bidirectionality. In the present description and drawings, elements that can be described in a like way will be denoted by a like reference character, and redundant description thereof will be omitted as needed.

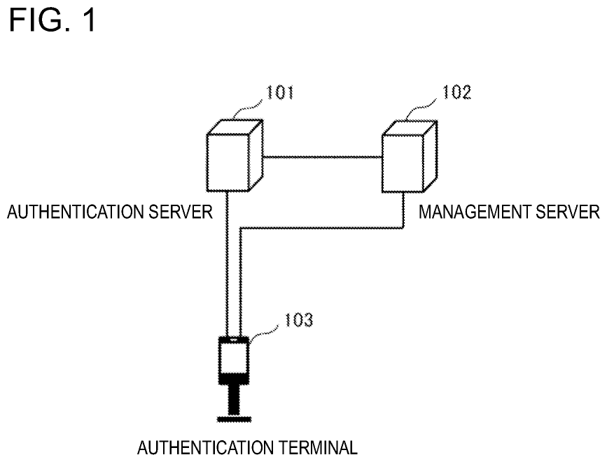

The system according to an example embodiment includes an authentication server 101, a management server 102 connected to the authentication server 101, and an authentication terminal 103 (see FIG. 1). The authentication server 101 stores biometric information and a user ID of each of a plurality of users in association with each other. The management server 102 stores the user ID of each of the plurality of users and information of at least one or more electronic coupons owned by each user in association with each other. The authentication terminal 103 is connected to the authentication server 101 and the management server 102. The authentication terminal 103 transmits an authentication request including the biometric information of a first user who uses the electronic coupon among the plurality of users to the authentication server 101. The authentication server 101 identifies a first user ID corresponding to the first user by a biometric authentication using the biometric information included in the authentication request, and also transmits a coupon information transmission instruction including the identified first user ID to the management server 102. The management server 102 transmits owned coupon information related to the electronic coupon owned by the first user corresponding to the first user ID included in the coupon information transmission instruction to the authentication terminal 103.

In the system shown in FIG. 1, a coupon (an electronic coupon) purchased by the user is stored in association with biometric information via a user ID. When a coupon purchaser uses the coupon, the authentication terminal 103 acquires the biometric information of the purchaser and requests an authentication to the authentication server 101. The authentication server 101 instructs the management server 102 that stores the user ID of the user and the information of the electronic coupon (for example, coupon ID) to transmit the information of the coupon owned by an authenticated person to the authentication terminal 103. The authentication terminal presents the received information on the owned coupon to the user, so that the user can easily select a coupon to use among the coupons owned by the user. As a result, the burden on the coupon purchaser is reduced.

Hereinafter, specific example embodiments will be described in more detail with reference to drawings.

### First Example Embodiment

A first example embodiment will be described in more detail with reference to drawings.

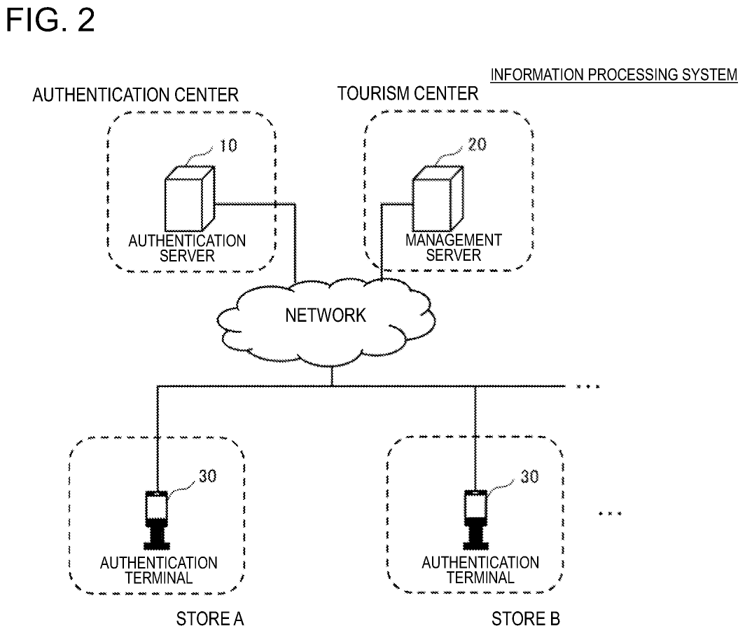

FIG. 2 is a diagram illustrating an example of a schematic configuration of an information processing system according to a first example embodiment. Referring to FIG. 2, the information processing system includes an authentication center, a tourist center, and a plurality of stores.

The information processing system shown in FIG. 2 is the system that sells a coupon to a user and manages the coupon sold to the user. For example, the information processing system sells a coupon that is intended to promote tourism and tourism reconstruction. The information processing system uses a biometric authentication to manage the sale and use of the coupon.

In the first example embodiment, a coupon handled by the information processing system is an electrical coupon (electronic coupon). A user who purchases an electronic coupon is able to receive benefits such as a discount that is greater than a purchase amount of the electronic coupon from a store affiliated with the system. A store that receives the electronic coupon is able to receive a refund of a discounted amount by contacting the tourism center with the used electronic coupon.

The authentication center is a company or an organization that provides services related to a biometric authentication. The authentication center includes an authentication server 10. The authentication server 10 is an apparatus that is responsible for a biometric authentication of the information processing system. The authentication server 10 may be installed in a building of the authentication center, or may be installed on the cloud.

The tourism center is an organization or a group that provides general services related to tourism and so on. The tourism center is sometimes referred to as a regional cooperative metropolitan area reconstruction company (DMO; Destination Management/Marketing Organization). The tourism center conducts PR (Public Relations) for a tourist spot and so on. In addition, the tourism center sells and manages a coupon that can be used commonly in a region. The tourism center includes a management server 20. The management server 20 may be installed in a building of the tourism center, or may be installed on the cloud.

A region under a jurisdiction of the tourism center includes a plurality of stores. A user is able to use an electronic coupon at a store affiliated with the information processing system (in a coupon provision system) among the plurality of stores.

An authentication terminal 30 is installed in the store affiliated with the system. A tourist or the like visiting a tourist spot uses the authentication terminal 30 to purchase a product or acquire tourist information (tour guide). In addition, the tourist or the like is able to use the electronic coupon purchased from the tourism center when purchasing a product using the authentication terminal 30.

The apparatuses illustrated in FIG. 2 are connected to each other. For example, the authentication server 10 and the management server 20 are each connected by wired or wireless communication means so that the authentication server 10 and the management server 20 can communicate with each other.

The configuration illustrated in FIG. 2 is an example and does not limit the configuration and so on of the information processing system disclosed in the present application. For example, two or more authentication servers 10 may be included in the authentication center. Alternatively, each store may include at least one or more authentication terminals 30.

### [Schematic Operation of System]

Next, a schematic operation of the information processing system according to the first example embodiment will be described.

### [User Registration]

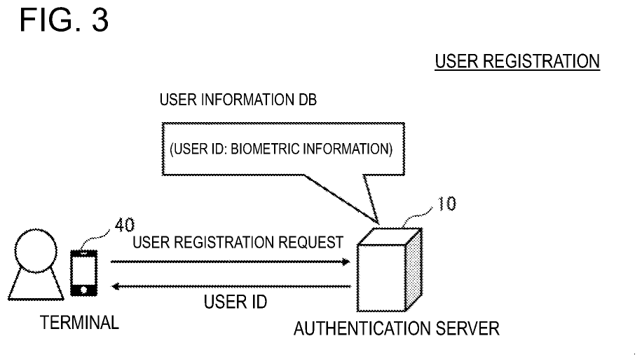

As shown in FIG. 3, a user who wishes to purchase an electronic coupon performs user registration in advance. The user registers his/her biometric information in the authentication server 10. For example, the user operates a terminal 40 in his/her possession and registers biometric information of the user in the authentication server 10. At that time, the terminal 40 transmits to the authentication server 10 a “user registration request” including the biometric information of the user.

For example, the biological information about a user is data (feature values) calculated from physical features unique to this individual user. The physical features are about the face, a fingerprint, a voiceprint, a vein, a retina, or an iris pattern of an eye of the user. Alternatively, the biological information about a user may be, for example, image data of a face image or a fingerprint image of the user. Any information including physical features of a user may be used as the biological information about the user. In the first example embodiment, the biometric information is a face image or a feature value generated from the face image.

When the authentication server 10 acquires the biometric information (for example, a face image), the authentication server 10 generates a user ID (Identifier) to identify the user. The authentication server 10 stores the biometric information and the user ID of the user in a user information database (DB; Database) in association with each other. The authentication server 10 stores the biometric information and the user ID of each of the plurality of users in association with each other by using the user information database.

The authentication server 10 issues the generated user ID to the user. More specifically, when the user registration is successful, the authentication server 10 transmits a positive response including the generated user ID to the terminal 40.

### [Purchase of Electronic Coupon]

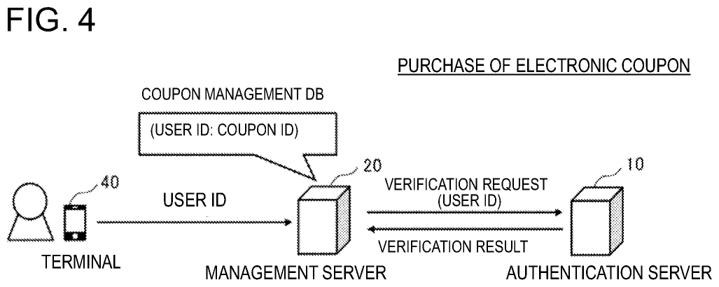

As shown in FIG. 4, a user accesses the management server 20 of the tourism center and purchases an electronic coupon. At that time, the user presents a user ID issued from the authentication server 10 to the management server 20.

The management server 20 requests the authentication server 10 to verify the presented user ID. Specifically, the management server 20 transmits a “verification request” including the user ID to the authentication server 10.

The authentication server 10 verifies whether or not the user ID included in the verification request is the user ID issued to the user who registered as a user in advance. Specifically, the authentication server verifies whether or not the user ID is registered in the user information database.

When the user ID is registered in the user information database, the authentication server 10 notifies the management server 20 of a “verification success”. When the user ID is not registered in the user information database, the authentication server 10 notifies the management server 20 of a “verification failure”.

The management server 20 does not sell an electronic coupon to the user when the user ID is not presented by the user, or when the verification result of the authentication server 10 is the “verification failure”.

When the verification result is the “verification success”, the management server 20 sells an electronic coupon to the user. When the electronic coupon is sold to the user, the management server 20 stores the user ID of the user and the ID of the electronic coupon sold to the user in a coupon management database in association with each other. The management server 20 stores the user ID of each of a plurality of users in association with the information (coupon IDs) of at least one or more electronic coupons owned by each user by using the coupon management database.

### [Use of Electronic Coupon]

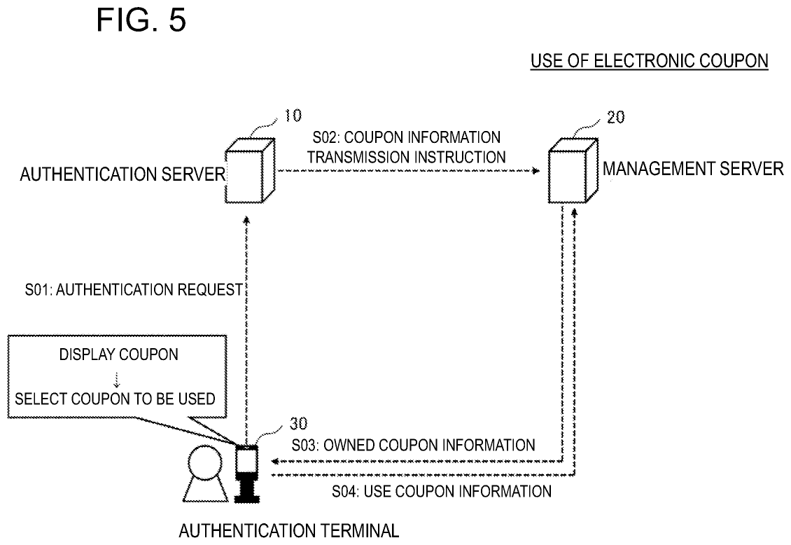

As shown in FIG. 5, a user who visits a store affiliated with the information processing system purchases a product and so on. After purchasing the product, the user uses the authentication terminal 30 to make a payment. At that time, the user can use an electronic coupon purchased from the tourism center.

When the user wishes to use the electronic coupon, the authentication terminal 30 acquires biometric information of the user (for example, a face image). The authentication terminal 30 transmits an “authentication request” including the acquired biometric information and a terminal ID to the authentication server 10 (S01).

The terminal ID is identification information to identify the authentication terminal 30. A MAC (Media Access Control) address or an IP (Internet Protocol) address of the authentication terminal 30 may be used for the terminal ID. The terminal ID is shared among the authentication server 10, the management server 20, and the authentication terminal 30 by any means.

The authentication server 10 identifies the user by biometric authentication (matching processing) using the acquired biometric information and the pre-registered biometric information. The authentication server 10 transmits a “coupon information transmission instruction” including the user ID of the identified user and the terminal ID to the management server 20 (S02).

The management server 20 extracts the user ID from the coupon information transmission instruction. The management server 20 accesses the coupon management database and acquires at least one or more coupon IDs stored in association with the extracted user ID.

The management server 20 transmits to the authentication terminal 30 “owned coupon information” including detailed information on the electronic coupon corresponding to the acquired coupon ID (S03). The management server 20 transmits the information of the coupon (the purchased coupon) owned by the user to the authentication terminal 30 as the “owned coupon information”.

Upon receiving the owned coupon information, the authentication terminal 30 displays a list of coupons held by the user who is present in front of the authentication terminal 30. The user who looks at the list selects the coupon to be used.

The authentication terminal 30 transmits “use coupon information” including the coupon ID of the selected coupon to the management server 20. After checking a validity of the selected electronic coupon, the management server 20 deletes the information of the used coupon from the coupon management database. In addition, the management server 20 pays a refund amount (discount amount) of the used coupon to the store where the electronic coupon was used.

Next, details of the individual apparatuses included in the information processing system according to the first example embodiment will be described.

### [Authentication Server]

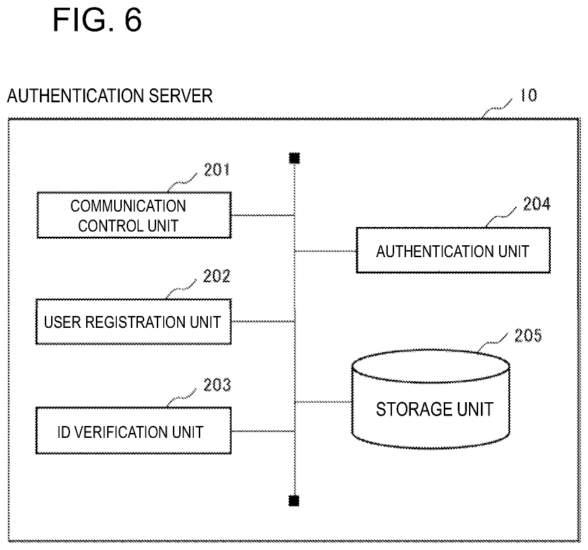

FIG. 6 is a diagram illustrating an example of a processing configuration (processing modules) of the authentication server 10 according to the first example embodiment. As illustrated in FIG. 6, the authentication server 10 includes a communication control unit 201, a user registration unit 202, an ID verification unit 203, an authentication unit 204, and a storage unit 205.

The communication control unit 201 is means for controlling communication with other apparatuses. For example, communication control unit 201 receives data (packets) from management server 20. In addition, the communication control unit 201 transmits data to the management server 20. The communication control unit 201 gives data received from other apparatuses to other processing modules. The communication control unit 201 transmits data acquired from other processing modules to other apparatuses. In this way, other processing modules transmit and receive data to and from other apparatuses via the communication control unit 201. The communication control unit 201 includes functions of a transmitting unit for transmitting information and a receiving unit for receiving information.

The user registration unit 202 is means for realizing the above user registration. The user registration unit 202 acquires biometric information of a user by using any means. For example, the user registration unit 202 receives a “user registration request” from the terminal 40 and acquires biometric information (for example, a face image). Alternatively, a user who wishes to register may send an external storage medium storing biometric information to the authentication center, and a staff member of the authentication center or the like may enter the biometric information into the authentication server 10 using the external storage medium.

The user registration unit 202 generates a feature value (a feature vector consisting of a plurality of feature values) from the acquired face image. Note that an existing technique is able to be used for the feature value generation process, and therefore, detailed description thereof will be omitted. For example, the user registration unit 202 extracts the eyes, nose, mouth, and so on from the face image as the feature points. Next, the user registration unit 202 calculates the location of an individual feature point and the distance between feature points as feature values and generates a feature vector formed by the plurality of feature values (vector information that characterizes the face image).

When the user registration unit 202 fails to generate a feature value from the acquired face image, the user registration unit 202 transmits a negative response to that effect to the terminal 40.

When the user registration unit 202 succeeds in generating a feature value, it generates a user ID to uniquely identify the user (a person who wishes to register). For example, the user registration unit 202 numbers the user ID each time a user is registered.

When the feature value is successfully generated, the user registration unit 202 transmits a positive response including the generated user ID to the terminal 40.

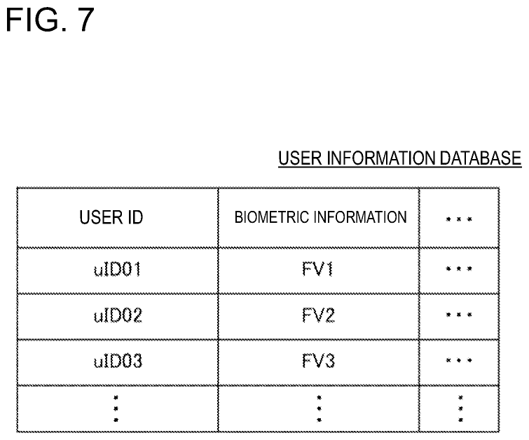

The user information registration unit 202 stores the generated user ID and the biometric information (for example, a feature value) in the user information database (see FIG. 7).

Note that the user information database shown in FIG. 7 is an example, and is not intended to limit items to be stored. For example, biometric information related to a face image may be stored in the user information database instead of or in addition to the feature value.

The ID verification unit 203 is means for verifying the user ID included in a verification request transmitted by the management server 20. The ID verification unit 203 extracts the user ID from the verification request. The ID verification unit 203 searches the user information database using the extracted user ID as a key.

When the search is successful, the ID verification unit 203 determines that the user ID is successfully verified. When the search fails, the ID verification unit 203 determines that the user ID fails to be verified. The ID verification unit 203 transmits a verification result (verification success or verification failure) to the management server 20.

The authentication unit 204 is means for processing an authentication request received from the authentication terminal 30. The authentication unit 204 extracts biometric information (for example, a face image) from the authentication request. The authentication unit 204 generates a feature value from the extracted face image.

The authentication unit 204 performs 1-to-N matching (N is a positive integer, and the same applies to the following description) by setting the generated feature value to a matching side and the feature values registered in the user information database to a registration side, respectively. Specifically, the authentication unit 204 calculates the degree of similarity between each feature value of the matching side and each feature value of a plurality of registration sides. For the individual similarity, the chi-squared distance, the Euclidean distance, and so on may be used. A longer distance represents a lower similarity, and a shorter distance represents a higher similarity.

The authentication unit 204 determines whether or not there is a feature value whose degree of similarity to the feature value to be matched is equal to or greater than a predetermined value among the plurality of feature values registered in the user information database. When such a feature value does not exist, the authentication unit 204 determines that the authentication fails.

When the feature value as described above exists, the authentication unit 204 determines that the authentication is successful. When authentication is successful, the authentication unit 204 identifies an entry with the highest similarity from among the entries in the user information database.

The authentication unit 204 transmits an authentication result to the authentication terminal 30. When the authentication fails, the authentication unit 204 transmits a negative response to that effect to the authentication terminal 30. When the authentication is successful, the authentication unit 204 transmits a positive response to that effect to the authentication terminal 30.

In addition, when the authentication is successful, the authentication unit 204 reads out the user ID of the entry identified above. The authentication unit 204 transmits to the management server a “coupon information transmission instruction” including the read-out user ID and the terminal ID acquired from the authentication terminal 30.

The storage unit 205 is means for storing information necessary for the operation of the authentication server 10.

### [Management Server]

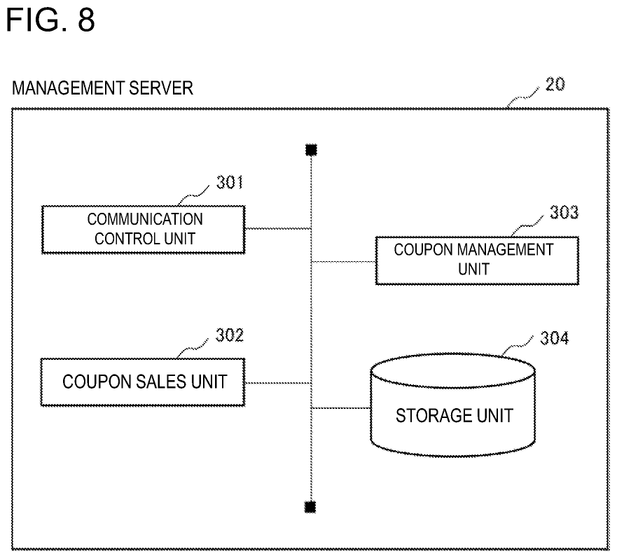

FIG. 8 is a diagram illustrating an example of a processing configuration (processing modules) of the management server 20 according to the first example embodiment. As illustrated in FIG. 8, the management server 20 includes a communication control unit 301, a coupon sales unit 302, a coupon management unit 303, and a storage unit 304.

The communication control unit 301 is means for controlling communication with other apparatuses. For example, the communication control unit 301 receives data (packets) from the authentication server 10. In addition, the communication control unit 301 transmits data to the authentication server 10. The communication control unit 301 gives data received from other apparatuses to other processing modules. The communication control unit 301 transmits data acquired from other processing modules to other apparatuses. In this way, other processing modules transmit and receive data to and from other apparatuses via the communication control unit 301. The communication control unit 301 includes the functions of a transmitting unit for transmitting information and a receiving unit for receiving information.

The coupon sales unit 302 is means for selling an electronic coupon. When the terminal 40 accesses a web page for selling coupons, the coupon sales unit 302 requests the terminal 40 to transmit a user ID to the terminal 40.

When the user ID is unable to be acquired from terminal 40, the coupon sales unit 302 does not sell a coupon to the user. This is because that the user does not complete the necessary user registration for purchasing a coupon.

When the user ID can be acquired from terminal 40, the coupon sales unit 302 transmits a verification request including the acquired user ID to the authentication server 10.

When a verification result from the authentication server 10 is “verification failure,” the coupon sales unit 302 does not sell a coupon to the user. This is also because that the user does not complete the necessary user registration for purchasing a coupon.

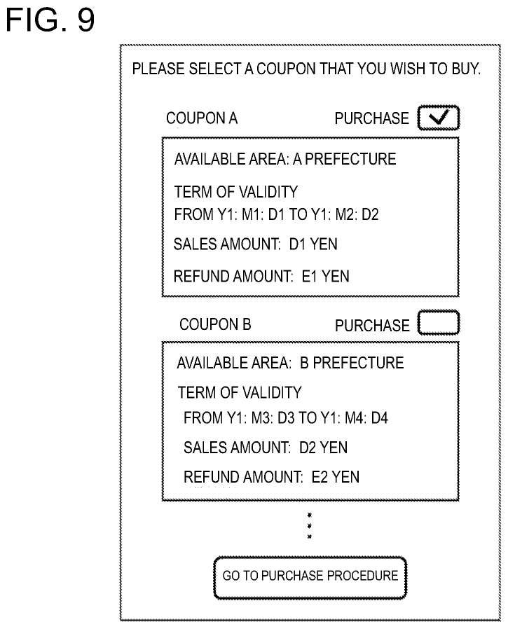

When the verification result from the authentication server 10 is “verification success,” the coupon sales unit 302 displays a page, an input form, and so on for selling an electronic coupon to the user on the terminal 40. For example, as shown in FIG. 9, the coupon sales unit 302 displays a name of an electronic coupon available for purchase, an area where the electronic coupon is able to be used, a validity period, a sales amount, a refund amount, and the like on the terminal 40.

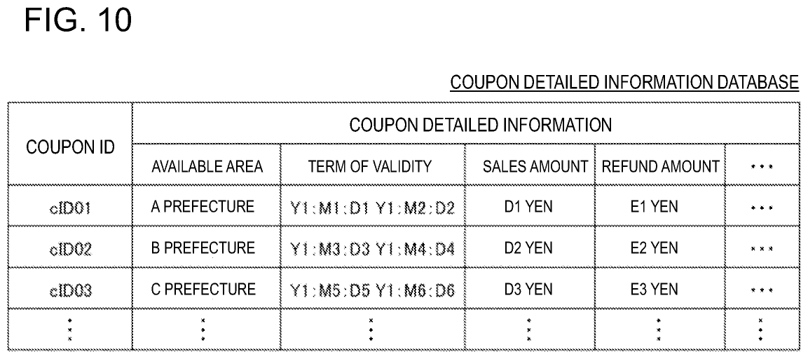

Note that when generating the display shown in FIG. 9, the coupon sales unit 302 refers to a coupon detailed information database that stores the coupon ID and the coupon detailed information in association with each other (see FIG. 10). As shown in FIG. 10, the coupon detailed information database stores the coupon ID and the coupon detailed information (the information including an area where the electronic coupon can be used, a validity period, a sales amount, a refund amount, and so on).

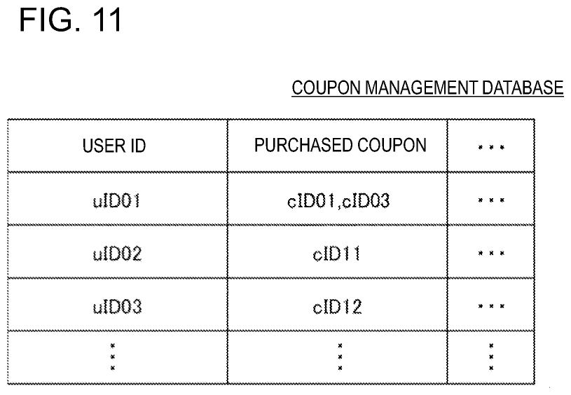

When a user purchases an electronic coupon (a payment for the electronic coupon is completed), the coupon sales unit 302 stores the user ID of the purchaser of the electronic coupon and the coupon ID of the sold electronic coupon in the coupon management database in association with each other (see FIG. 11).

Note that the same user may purchase an additional electronic coupon. In such a case, the coupon sales unit 302 appends the coupon ID of the sold electronic coupon to the purchase coupon entry in the coupon management database (see the first line in FIG. 11).

The coupon management unit 303 is means for managing an electronic coupon sold to the user. The coupon management unit 303 receives a “coupon information transmit instruction” from the authentication server 10. The coupon management unit 303 extracts the user ID from the instruction.

The coupon management unit 303 searches the coupon management database using the extracted user ID as a key and identifies a corresponding entry. The coupon management unit 303 reads the coupon ID described in the purchase coupon field of the identified entry. The coupon management unit 303 refers to the coupon detailed information database and acquires information (a coupon ID and coupon detailed information) described in the entry corresponding to the read coupon ID. For example, when a user assigned “uID01” as the user ID uses an electronic coupon, the coupon detailed information corresponding to the coupon IDs “cID01” and “cID03” of the purchased coupons is read out (see line 1 of FIG. 11 and lines 1 and 3 of FIG. 10).

The coupon management unit 303 generates “owned coupon information” based on the acquired coupon ID and the coupon detailed information.

The coupon management unit 303 generates the owned coupon information including the user ID of the user (the user ID acquired from the authentication server 10), the coupon ID, and the coupon detailed information. The coupon management unit 303 transmits the generated owned coupon information to the authentication terminal 30 corresponding to the terminal ID acquired from the authentication server 10.

The coupon management unit 303 receives “use coupon information” from the authentication terminal 30. The coupon management unit 303 searches the coupon management database using the user ID included in the use coupon information as a key and identifies a corresponding entry.

The coupon management unit 303 checks a validity of the coupon ID included in the use coupon information among the coupon IDs listed in the purchased coupon field of the identified entry. For example, the coupon management unit 303 determines an area where the electronic coupon is used from the terminal ID of the authentication terminal 30 and verifies whether or not the area is included in an available area for the coupon to be used. Also, the coupon management unit 303 verifies whether or not the date and time of usage of the electronic coupon is included in a validity period of the coupon to be used.

When the coupon management unit 303 determines through the above verification that the electronic coupon that the user wishes to use is valid, the coupon management unit 303 notifies the authentication terminal 30 that the electronic coupon can be used. After that, the coupon management unit 303 deletes the coupon ID of the coupon to be used among the coupon IDs listed in the purchased coupon field in the coupon management database.

When the electronic coupon that the user wishes to use is determined to be invalid (the user is unable to use the electronic coupon) by the above verification, the coupon management unit 303 notifies the authentication terminal 30 that the user is unable to use the electronic coupon.

In addition, the coupon management unit 303 pays a refund amount of the used coupon to the store where the user used the electronic coupon (the store where the authentication terminal 30 is installed). Specifically, the coupon management unit 303 refers to table information that associates the terminal ID with information on the payee of the refunded amount (for example, a bank account, credit card information), and pays the refund amount.

Note that the coupon management unit 303 may pay the refund amount each time the electronic coupon is used, or may collectively pay the refund amount accumulated by a predetermined timing (for example, by the end of the month).

The storage unit 304 is means for storing information necessary for the operation of the management server 20.

### [Authentication Terminal]

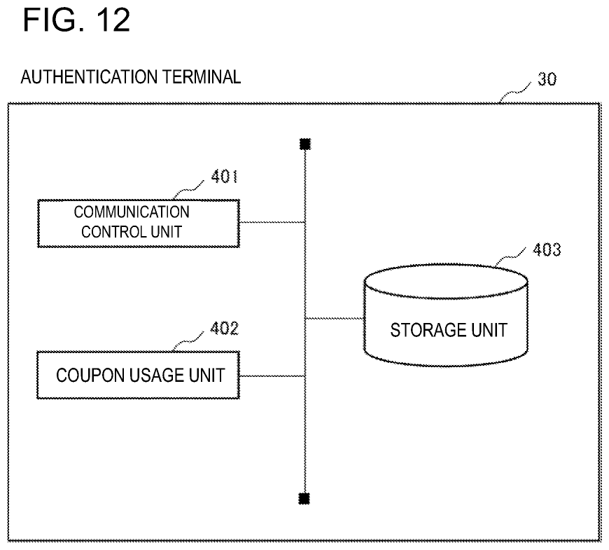

FIG. 12 is a diagram illustrating an example of a processing configuration (processing modules) of the authentication terminal 30 according to the first example embodiment. Referring to FIG. 12, the authentication terminal 30 includes a communication control unit 401, a coupon usage unit 402, and a storage unit 403.

The communication control unit 401 is means for controlling communication with other apparatuses. For example, the communication control unit 401 receives data (packets) from the authentication server 10. Also, the communication control unit 401 transmits data to the authentication server 10. The communication control unit 401 gives data received from other apparatuses to other processing modules. The communication control unit 401 transmits data acquired from other processing modules to other apparatuses. In this way, other processing modules transmit and receive data to and from other apparatuses via the communication control unit 401. The communication control unit 401 includes the functions of a transmitting unit for transmitting information and a receiving unit for receiving information.

The coupon usage unit 402 is means for controlling the use of an electronic coupon by a user. When a user wishes to use a coupon when paying for a product, the coupon usage unit 402 acquires biometric information of the user.

The coupon usage unit 402 controls a camera and acquires biometric information (a face image) of the user. More specifically, the coupon usage unit 402 determines whether or not the acquired image includes the face image of the person, and when the face image is included, the coupon usage unit 402 extracts the face image from the acquired image data.

Note that an existing technique is able to be used for the face image extraction processing performed by the coupon usage unit 402, and therefore, detailed description thereof will be omitted. For example, the coupon usage unit 402 may extract the face image (the face area) from the image data by using a learning model learned by a CNN (Convolutional Neural Network). Alternatively, the coupon usage unit 402 may extract the face image by using a technique such as template matching.

The coupon usage unit 402 transmits an authentication request including the extracted face image (biometric information) and the terminal ID of the own device to the authentication server 10.

The coupon usage unit 402 acquires an authentication result (authentication success or authentication failure) from the authentication server 10.

When the authentication fails, the coupon usage unit 402 notifies the user that the coupon is unable to be used.

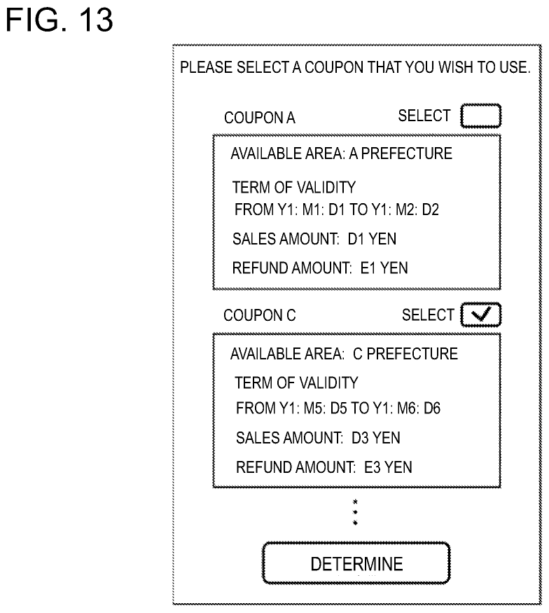

When the authentication is successful, the coupon usage unit 402 waits until the coupon usage unit 402 receives “owned coupon information” from the management server 20. The coupon usage unit 402 displays a GUI (Graphical User Interface) that allows the user to select a coupon to be used based on the received owned coupon information. For example, the coupon usage unit 402 displays a GUI as illustrated in FIG. 13 on the terminal 40.

The coupon usage unit 402 acquires the coupon ID corresponding to the electronic coupon that the user wishes to use through the GUI as shown in FIG. 13. The coupon usage unit 402 transmits “use coupon information” including the acquired coupon ID, the user ID of the user (the user ID included in the owned coupon information) and the terminal ID to the management server 20.

When the coupon usage unit 402 is notified by the management server 20 that the coupon selected by the user cannot be used, the coupon usage unit 402 notifies the user of the fact.

When the coupon usage unit 402 is notified by the management server 20 that the user can use the coupon selected by the user, the coupon usage unit 402 notifies a payment module (not shown in FIG. 12), that is in charge of payment processing, of this fact. The payment module reduces the discount amount of the electronic coupon and makes the payment for the purchase of a product. Note that a detailed explanation of the processing of payment for products is omitted since it is different from the purpose of the present application.

The storage unit 403 is means for storing information necessary for the operation of the authentication terminal 30.

### [Terminal]

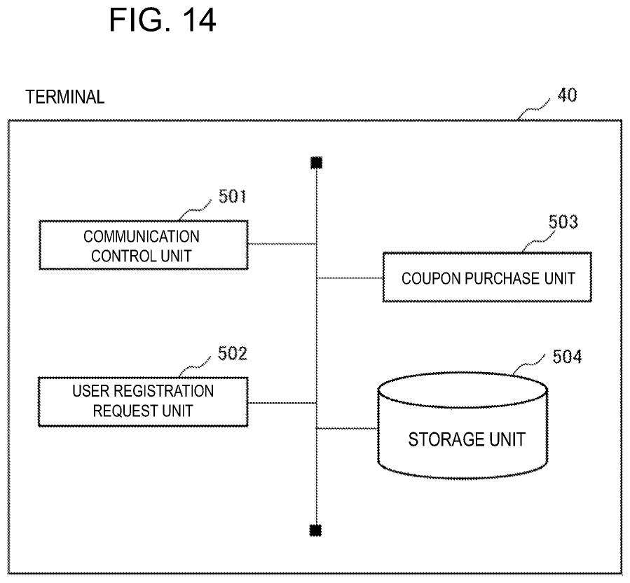

FIG. 14 is a diagram illustrating an example of a processing configuration (processing modules) of the terminal 40 according to the first example embodiment. Referring to FIG. 14, the terminal 40 includes a communication control unit 501, a user registration request unit 502, a coupon purchase unit 503, and a storage unit 504.

The communication control unit 501 is means for controlling communication with other apparatuses. For example, the communication control unit 501 receives data (packets) from the authentication server 10. Also, the communication control unit 501 transmits data toward the authentication server 10. The communication control unit 501 gives data received from other apparatuses to other processing modules. The communication control unit 501 transmits data acquired from other processing modules to other apparatuses. In this way, other processing modules transmit and receive data to and from other apparatuses via the communication control unit 501. The communication control unit 501 includes the functions of a transmitting unit for transmitting information and a receiving unit for receiving information.

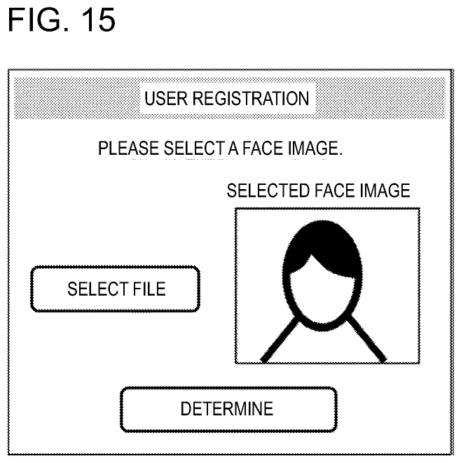

The user registration request unit 502 is means for transmitting a user registration request to the authentication server 10. The user registration request unit 502, for example, acquires biometric information (a face image) through a GUI as shown in FIG. 15. The user registration request unit 502 transmits the user registration request including the acquired face image to the authentication server 10.

When a negative response is received from the authentication server 10, the user registration request unit 502 notifies the user that the user registration has failed.

When a positive response is received from the authentication server 10, the user registration request unit 502 notifies the user that the user registration has been successful. Further, the user registration request unit 502 stores the user ID included in the positive response in the storage unit 504.

The coupon purchase unit 503 is means for the user to purchase an electronic coupon. When the coupon purchase unit 503 is requested by the management server 20 to provide a user ID, the coupon purchase unit 503 reads the user ID stored in the storage unit 504 and transmits the user ID to the management server 20.

The coupon purchase unit 503 notifies the management server 20 of the operation of the user who looks at the display shown in FIG. 9. Note that a detailed explanation of the payment processing of the electronic coupon is omitted because it is different from the purpose of the present application.

The storage unit 504 is means for storing information necessary for the operation of the terminal 40.

### [System Operation]

Next, operations of the information processing system according to the first example embodiment will be described. Note that descriptions of operations related to the user registration and the purchase of an electronic coupon are omitted.

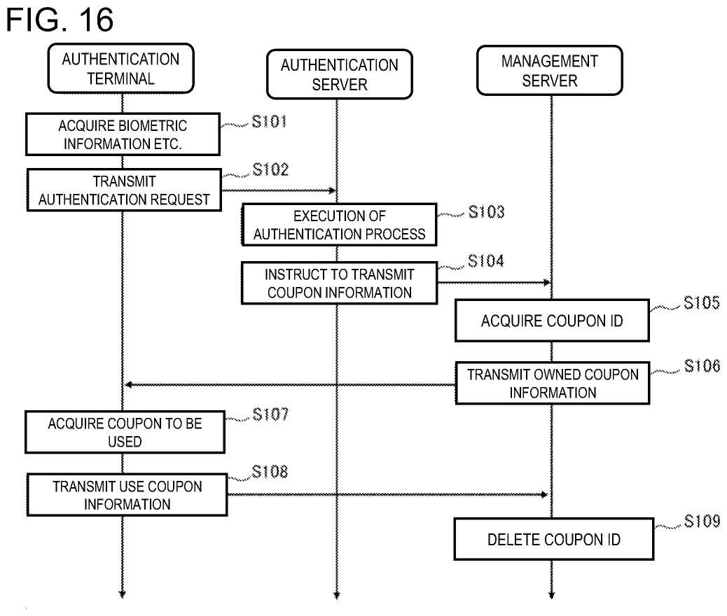

FIG. 16 is a sequence diagram illustrating an example of an operation in the information processing system according to the first example embodiment.

When a user wishes to use a coupon, the authentication terminal acquires biometric information of the user (step S101).

The authentication terminal 30 transmits an authentication request including the biometric information of the user to the authentication server 10 (step S102). The authentication terminal 30 transmits the authentication request including the biometric information of the first user who uses the electronic coupon among the plurality of users to the authentication server 10.

The authentication server 10 executes biometric authentication using the biometric information included in the authentication request and identifies the user (execution of authentication process; step S103).

The authentication server 10 instructs the management server 20 to transmit the coupon information (step S104). The authentication server 10 transmits a coupon information transmission instruction including the user ID of the identified user to the management server 20.

In this way, the authentication server 10 identifies a first user ID corresponding to the first user by the biometric authentication using the biometric information included in the authentication request, and transmits the coupon information transmission instruction including the identified first user ID to the management server 20.

The management server 20 accesses the coupon management database using the user ID included in the coupon information transmit instruction and acquires the coupon ID related to the electronic coupon that the user already purchased (step S105).

The management server 20 generates owned coupon information to create a list of coupons that can be used by the user based on the acquired coupon ID and transmits the owned coupon information to the authentication terminal 30 (step S106).

In this way, the management server 20 transmits to the authentication terminal 30 the owned coupon information related to the electronic coupon owned by the first user corresponding to the first user ID included in the coupon information transmission instruction. The owned coupon information includes the coupon ID of the electronic coupon owned by the first user and detailed information of the electronic coupon.

The authentication terminal 30 displays a GUI for the user to select a coupon to use based on the acquired owned coupon information, and acquires the coupon to be used (step S107). The authentication terminal 30 uses the owned coupon information to display a GUI for selecting the electronic coupon that the first user wishes to use.

The authentication terminal 30 transmits the use coupon information including the coupon ID of the used electronic coupon to the management server 20 (step S108). The authentication terminal 30 transmits the use coupon information related to the electronic coupon that the first user wishes to use to the management server 20. The use coupon information includes the coupon ID of the electronic coupon selected by the first user.

The management server 20 checks the validity of the used electronic coupon, and when a valid electronic coupon is used, the coupon ID of the electronic coupon is deleted from the coupon management database (step S109). After verifying the validity of the electronic coupons that the first user wishes to use, as notified by the use coupon information, the management server 20 deletes the electronic coupon whose validity is verified.

As described above, in the information processing system according to the first example embodiment, the authentication server 10 stores the user ID and biometric information of the user. Also, the management server 20 stores the user ID of the user and the information of the electronic coupon (the coupon IDs). When an electronic coupon is used, the user is identified by biometric authentication and the user ID is transmitted to the management server 20. The management server transmits the electronic coupon information associated with the user ID to the authentication terminal 30. The authentication terminal 30 displays a list of coupons owned by the user (the authenticated person) based on the received electronic coupon information, and allows the user to select a coupon to be used. As a result, the user does not need to manage the purchased coupons by himself/herself, and the convenience at the time of using the coupon is able to be improved. In addition, since the user does not need his/her own terminal 40 to use the purchased coupon, the user can easily use the purchased electronic coupon even if he/she does not own the terminal 40.

In addition, as in the configuration of the information system according to the first example embodiment, by separating the entity (server) that holds the coupon information and the entity that holds the biometric information, even if an information leak occurs from either one of them, the damage can be minimized.

Furthermore, in the information processing system according to the first example embodiment, the user who purchased an electronic coupon presents the electronic coupon to the store. The user is able to receive a benefit (a discount) after the validity and so on of the electronic coupon is checked. When the electronic coupon is used, the management server 20 pays the discounted amount to each store. Thus, in the first example embodiment, it is not necessary to hand over a used coupon (a paper coupon) to a tourism center and so on, and then receive a cash exchange. Therefore, the labor needed by each store for the use of electronic coupons is reduced.

### Second Example Embodiment

Next, a second example embodiment will be described in detail with reference to drawings.

The first example embodiment describes a case in which a coupon handled by the information processing system is an electronic coupon. However, there are some difficult aspects in handling electronic coupons, such as the need to prepare an EC (Electronic Commerce) site in order for a tourism center to handle the sale of an electronic coupon. In some cases, especially when a coupon needs to be issued quickly, it is easier to issue a paper coupon (hereinafter referred to as a “paper coupon”) than an electronic coupon.

The second example embodiment describes a case in which the tourism center issues a paper coupon. However, even in the second example embodiment, it is the same that a biometric authentication is performed at each store affiliated with the system, and a user is identified.

The following description will be made with a focus on the difference between the first and second example embodiments below.

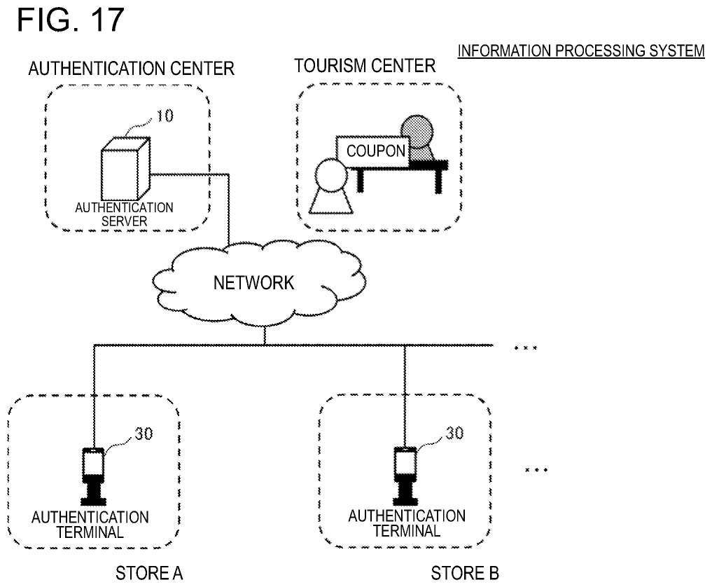

FIG. 17 is a diagram illustrating an example of a schematic configuration of an information processing system according to the second example embodiment. As shown in FIG. 17, a management server is not included in the second example embodiment.

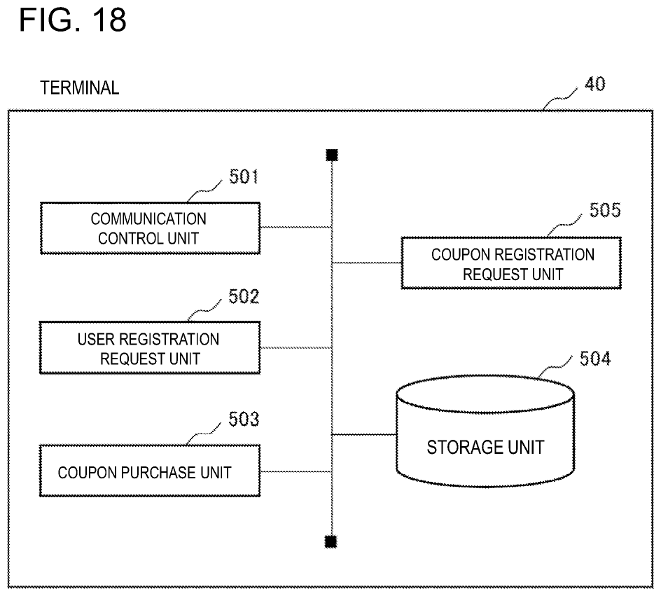

FIG. 18 is a diagram illustrating an example of a processing configuration (processing modules) of a terminal 40 according to the second example embodiment. Referring to FIG. 18, a coupon registration request unit 505 is added to the configuration of the terminal 40 according to the first example embodiment.

The coupon registration request unit 505 is means for requesting an authentication server 10 to register the paper coupon purchased by the user.

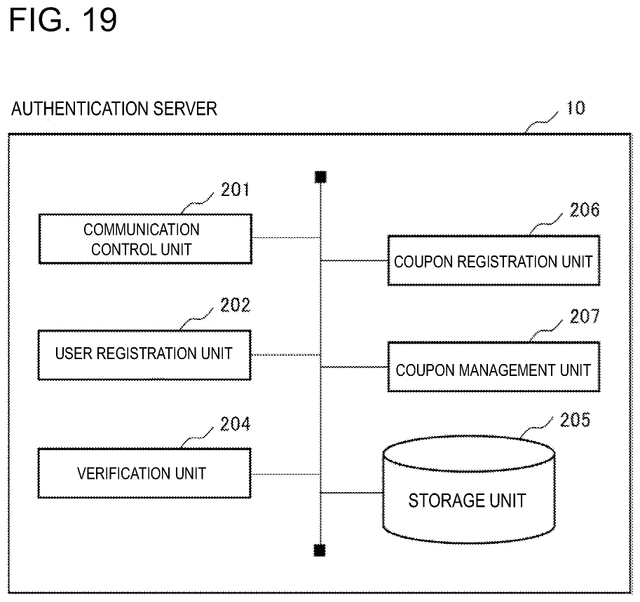

FIG. 19 is a diagram illustrating an example of a processing configuration (processing modules) of the authentication server 10 according to the second example embodiment. Referring to FIG. 19, a coupon registration unit 206 and a coupon management unit 207 are added to the configuration of the authentication server 10 according to the first example embodiment. Moreover, the authentication server 10 according to the second example embodiment may not include an ID verification unit 203 as shown in FIG. 19. Note that the authentication server 10 according to the second example embodiment includes a coupon detailed information database as shown in FIG. 10 related to a paper coupon.

The coupon registration unit 206 is means for processing a coupon registration request received from the terminal 40.

The coupon management unit 207 is means for managing a coupon sold to the user.

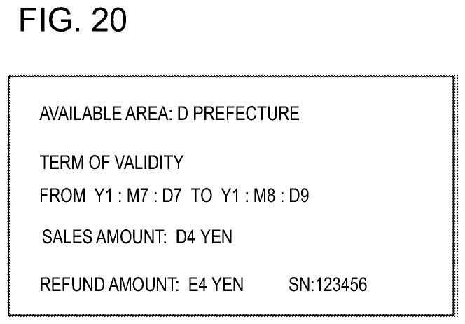

In the second example embodiment, a user purchases a paper coupon from the tourism center. For example, the user purchases a paper coupon as shown in FIG. 20.

The user who purchased the paper coupon operates the terminal to register the purchased paper coupon with the authentication server 10. At that time, the terminal 40 photographs the paper coupon and the user. For example, the terminal 40 generates and displays a GUI for acquiring biometric information (a face image) of the user and a paper coupon image.

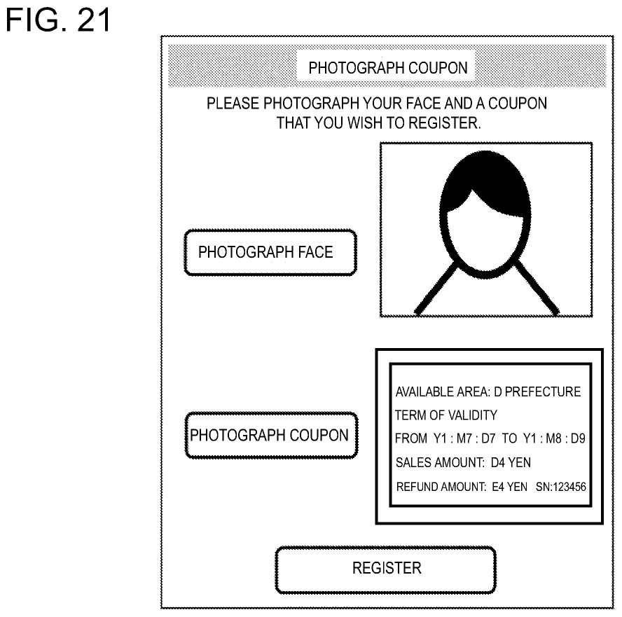

For example, the coupon registration request unit 505 acquires the biometric information (the face image) of the user and the paper coupon image that is photographed the paper coupon by using the GUI as shown in FIG. 21. The user presses a photograph button at his/her own timing while visually checking the face to be photographed by a camera and the paper coupon in a preview area provided on the right side of a face photographing button and a coupon photographing button.

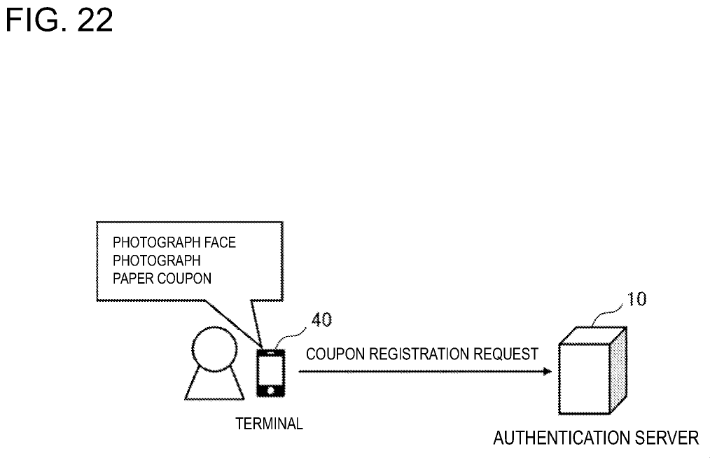

The coupon registration request unit 505 transmits a “coupon registration request” including the acquired biometric information (the face image) and the paper coupon image to the authentication server 10 (see FIG. 22).

Upon receiving the coupon registration request, the authentication server 10 performs biometric authentication by using the authentication unit 204. The authentication unit 204 identifies the user by a matching process (1-to-N matching; N is a positive integer) using the biometric information included in the coupon registration request and the biometric information registered in the user information database.

The authentication unit 204 notifies the coupon registration unit 206 of a result of the biometric authentication.

When the authentication is successful, the coupon registration unit 206 registers the paper coupon photographed in the paper coupon image included in the coupon registration request in the user information registration database.

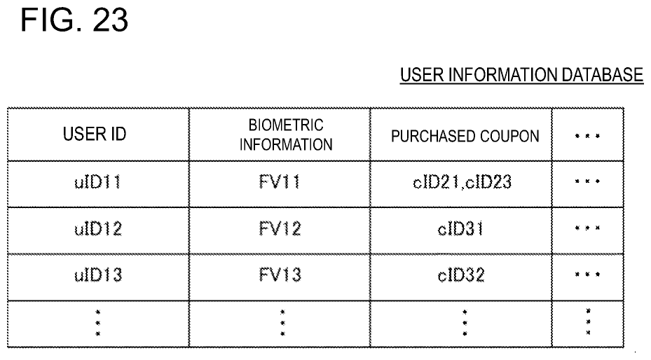

Specifically, the coupon registration unit 206 identifies a type of coupon purchased by the user by analyzing the paper coupon image. The coupon registration unit 206 stores (appends) a coupon ID corresponding to the identified coupon type in the user information database (see FIG. 23). As shown in FIG. 23, the authentication server 10 uses the user information database to store the biometric information of each of a plurality of users and information (the coupon IDs) of at least one or more paper coupons owned by each user in association with each other.

Note that a learning model prepared in advance is able to be used to analyze the paper coupon image. Specifically, machine learning is performed using teacher data in which a label (a coupon ID) is assigned to a paper coupon image, and a learning model (an identifier) is generated. The coupon registration unit 206 is able to acquire the coupon ID by inputting the paper coupon image to the generated learning model. Any algorithm, such as support vector machine, boosting, or neural network, may be used to generate the learning model. Since known techniques can be used for the above algorithms such as support vector machine, description thereof will be omitted.

The coupon registration unit 206 transmits a positive response to the terminal 40 when the coupon registration request is normally processed. For example, when the coupon registration request is not able to be processed normally, such as when the authentication fails, the coupon registration unit 206 transmits a negative response to the terminal 40.

Note that the authentication unit 204 processes the authentication request received from the authentication terminal 30 in the same manner as in the first example embodiment. When the biometric authentication of the user is successful, the authentication unit 204 notifies the coupon management unit 207 of the user ID of the identified user.

The coupon management unit 207 performs an operation in accordance with the coupon management unit 303 of the management server 20 according to the first example embodiment. Specifically, the coupon management unit 207 acquires the coupon ID of the paper coupon from the user information database using the notified user ID. For example, in the example of FIG. 23, when “uID11” is notified as the user ID, the coupon management unit 207 acquires the coupon IDs of “cID21” and “cID23” from the corresponding purchase coupon field. The coupon management unit 207 acquires coupon detailed information from the coupon detailed information database using the acquired coupon ID.

The coupon management unit 207 transmits owned coupon information including the user ID, the coupon ID, and the coupon detailed information to the authentication terminal 30.

Furthermore, the coupon management unit 207 acquires the use coupon information from the authentication terminal 30 and performs processing related to the coupon to be used by the user. Specifically, the coupon management unit 207 checks a validity of the used coupon, and when a valid paper coupon was used, the coupon ID of the paper coupon is deleted from the user information database.

Note that since the management server 20 does not exist in the second example embodiment, the authentication center (the authentication server 10) notifies the tourism center of an usage record of the paper coupon periodically or at a predetermined timing. The tourism center receives the usage record of the coupon and calculates a refund amount to be paid to each store. The refund amount is paid online or offline to each store.

Next, operations of the information processing system according to the second example embodiment will be described.

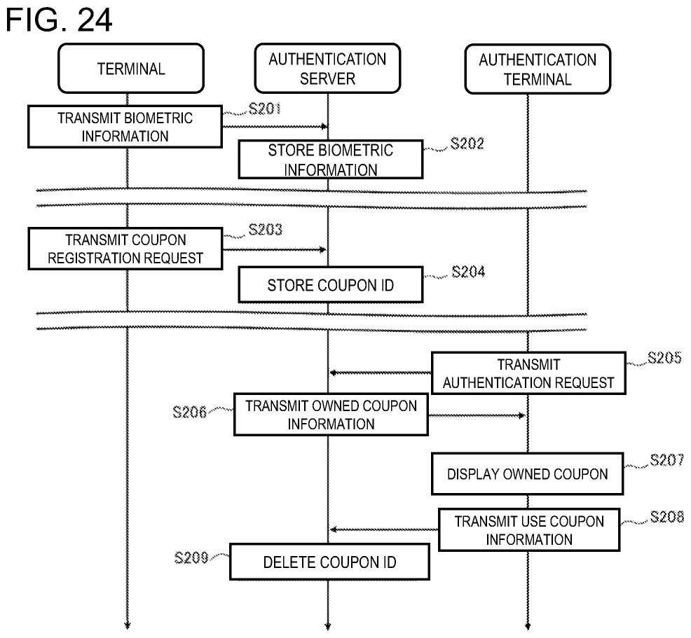

FIG. 24 is a sequence diagram illustrating an example of an operation in the information processing system according to the second example embodiment.

The terminal 40 transmits biometric information (for example, a face image) of a user to the authentication server 10 (step S201).

The authentication server 10 generates the feature values (the biometric information) from the received face image and stores it in the user information database (step S202). Note that in the second example embodiment, the authentication server 10 does not have to issue the user ID to the terminal 40.

The user purchases a paper coupon from the tourism center. The user registers the purchased paper coupon in the authentication server 10. Specifically, the terminal 40 transmits to the authentication server a coupon registration request including the biometric information of the user and the paper coupon image that is photographed the paper coupon (step S203).

The authentication server 10 identifies the user by biometric authentication and stores the coupon ID of the paper coupon in the user information database (step S204).

In this way, the terminal 40 transmits the coupon registration request to the authentication server 10 that includes the biometric information of the user and the paper coupon image that is photographed the paper coupon purchased by the user. The authentication server 10 identifies the user by the biometric authentication using the biometric information included in the coupon registration request, and stores the identified user and the information (the coupon IDs) of the paper coupon acquired from the paper coupon image in association with each other.

The user visits a store and purchases a product. The user performs a payment procedure at the time of purchase of the product using the authentication terminal 30.

The authentication terminal 30 acquires biometric information of the purchaser (the authenticated person) and transmits an authentication request including the biometric information to the authentication server (step S205). The authentication terminal 30 transmits the authentication request including the biometric information of a second user who uses the paper coupon among a plurality of users to the authentication server 10.

The authentication server 10 identifies the purchaser by the biometric authentication and transmits “owned coupon information” related to the paper coupon owned by the identified purchaser to the authentication terminal 30 (step S206). The authentication server 10 identifies the second user by the biometric authentication using the biometric information included in the authentication request, and transmits owned coupon information related to the paper coupon owned by the identified second user to the authentication terminal 30.

The authentication terminal 30 displays a list of paper coupons owned by the user based on the received owned coupon information (display of owned coupons; step S207).

The user selects the paper coupon to be used from the displayed list. The authentication terminal 30 transmits use coupon information related to the selected paper coupon to the authentication server 10 (step S208).

The authentication server 10 verifies a validity of the coupon to be used and notifies the authentication terminal 30 whether or not the coupon can be used. When the use coupon is valid, the authentication server 10 deletes the corresponding coupon ID from the user information database (step S209).

When the coupon to be used (the paper coupon selected by the user) is valid, the authentication terminal 30 performs the payment process while providing a discounting with the paper coupon. Note that the payment processing may be any one of payment using a biometric authentication (for example, face payment), a cash payment, and an electronic payment.

The authentication center notifies the tourism center of the used coupon information. The tourism center performs cash conversion processing corresponding to the used paper coupon. Specifically, the tourism center transfers a predetermined amount of money to the store where the paper coupon was used.

Note that a staff member of the tourism center or the like may collect and discard the paper coupon that is registered in the system. In other words, when the user purchases the paper coupon, the user photographs the paper coupon and hands over the paper coupon registered in the system to the staff member or the like of the tourism center. The staff member or the like cuts and discards the collected paper coupon.

### <Variation 1 According to the Second Example Embodiment>

In the above description, it is explained that the terminal 40 acquires the face image and the paper coupon image at the same time (on the same screen) when registering the paper coupon. However, the terminal 40 may acquire these images at different timings.

For example, the terminal 40 internally manages the registered paper coupon image and the unregistered paper coupon image, and displays a list related to these images in response to a request from the user. Further, the terminal 40 may display a button and so on for registering the unregistered paper coupon image, while displaying the registered paper coupon image and the unregistered paper coupon image so that the user is able to distinguish between the registered paper coupon image and the unregistered paper coupon image.

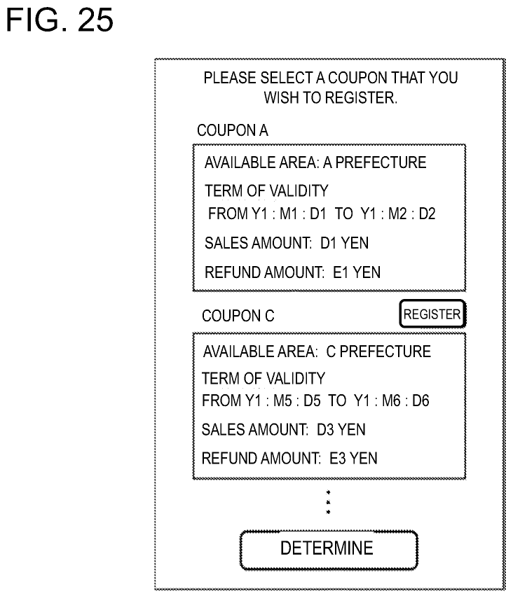

For example, the coupon registration request unit 505 displays a GUI as shown in FIG. 25. In FIG. 25, the registered paper coupon image is indicated by a solid line, and the unregistered paper coupon image is indicated by a dotted line. In addition, a “registration” button is displayed for registering the unregistered paper coupon image.

When the “registration” button related to the unregistered paper coupon image is pressed, the coupon registration request unit 505 shifts to the GUI for acquiring the face image of the user, and acquires the face image. In this way, the coupon registration request unit 505 may transmit to the authentication server 10 the coupon registration request that includes the face image (the biometric information) and the paper coupon image acquired at different timings.

### <Variation 2 According to the Second Example Embodiment>

Here, when a serial number (SN) is assigned to the paper coupon as shown in FIG. 20, the coupon management unit 206 preferably manages the serial number together. The coupon registration unit 206 is able to acquire the serial number from the paper coupon image by using an optical character recognition technology (OCR; Optical Character Reader).

When the serial number is written on the paper coupon, the coupon management unit 206 manages the serial number of the registered paper coupons by using a list. When registering the paper coupon, the coupon registration unit 206 checks the list and rejects the registration of the paper coupon that has the same serial number as the serial number registered in the list. The coupon registration unit 206 prevents a sold paper coupon from being used multiple times by rejecting the registration of such a paper coupon.

As described above, in the information processing system according to the second example embodiment, the user photographs the paper coupon purchased from the tourism center and registers the information of the paper coupon together with the biometric information in the authentication server 10. When the paper coupon is used, as in the first example embodiment, the user is identified by the biometric authentication and the information of the corresponding coupon is transmitted to the authentication terminal 30. The authentication terminal 30 displays the list of coupons that can be used by the user (the authenticated person) and allows the user to select a coupon to be used. Thus, in the second example embodiment, even if the paper coupon is purchased from the tourism center, the paper coupon is digitized and registered in the authentication server 10, and the user is able to use the coupon in the same manner as the electronic coupon.

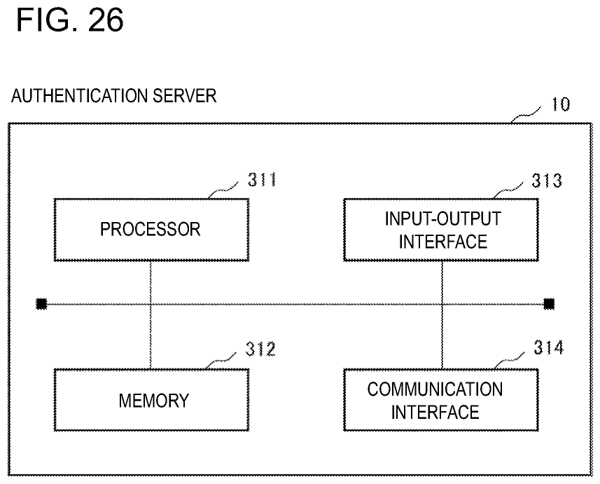

Next, a hardware configuration of an individual apparatus that constitutes the information processing system will be described. FIG. 26 is a diagram illustrating an example of a hardware configuration of the authentication server 10.

The authentication server 10 can be configured by an information processing apparatus (a so-called computer) and has a configuration illustrated as an example in FIG. 26. For example, the authentication server 10 includes a processor 311, a memory 312, an input-output interface 313, a communication interface 314, and so on. The components such as the processor 311 are connected to an internal bus, and so on so that these components can communicate with each other.

The hardware configuration of the authentication server 10 is not limited to the configuration illustrated in FIG. 26. The authentication server 10 may include hardware not illustrated or may be configured without the input-output interface 313 if desired. In addition, the number of components, such as the number of processors 311, included in the authentication server 10 is not limited to the example illustrated in FIG. 26. For example, a plurality of processors 311 may be included in the server apparatus 10.

For example, the processor 311 is a programmable device such as a CPU (Central Processing Unit), an MPU (Micro Processing Unit), or a DSP (Digital Signal Processor). Alternatively, the processor 311 may be a device such as an FPGA (Field Programmable Gate Array) or an ASIC (Application Specific Integrated Circuit). The processor 311 executes various kinds of programs including an operating system (OS).

The memory 312 is a RAM (Random Access Memory), a ROM (Read-Only Memory), an HDD (Hard Disk Drive), an SSD (Solid State Drive), and so on. The memory 312 stores an OS program, an application program, and various kinds of data.

The input-output interface 313 is an interface for a display apparatus and an input apparatus not illustrated. For example, the display apparatus is a liquid crystal display and so on. For example, the input apparatus is an apparatus that receives user operations, and examples of the input apparatus include a keyboard and a mouse.

The communication interface 314 is a circuit, a module, and so on for performing communication with other apparatuses. For example, the communication interface 314 includes a NIC (Network Interface Card) and so on.

The functions of the authentication server 10 are realized by various kinds of processing modules. The processing modules are realized, for example, by causing the processor 311 to execute a program stored in the memory 312. In addition, this program can be recorded in a computer-readable storage medium. The storage medium may be a non-transient (non-transitory) storage medium, such as a semiconductor memory, a hard disk, a magnetic recording medium, or an optical recording medium. That is, the present invention can be embodied as a computer program product. In addition, the above program may be updated by downloading a program via a network or by using a storage medium in which a program is stored. In addition, the above processing modules may be realized by semiconductor chips.

As is the case with the management server 20, the authentication terminal 30, and the terminal 40 can each be configured by an information processing apparatus, and the basic hardware configuration of the management server 20, the authentication terminal 30, and the terminal 40 is the same as that of the authentication server 10. Thus, description of the basic hardware configuration of the management server 20, the authentication terminal 30, and the terminal 40 will be omitted. For example, the authentication terminal 30 may include a camera for photographing a user.

The authentication server 10, which is an information processing apparatus, includes a computer, and the functions of the authentication server 10 can be realized by causing the computer to execute a program. In addition, the authentication server 10 executes the control method of the authentication server 10 by the program. Further, when each of the entities (the authentication server 10 and so on) included in the information processing system operates, a method related to a coupon management and a coupon usage is executed.

### [Variations]

The configurations, operations, and so on of the information processing system according to the above example embodiments are examples and do not limit the present system configuration, and so on.

In the above example embodiments, it is described that the authentication server 10 includes a user information database and the management server 20 includes a coupon management database. However, these databases may be built in a database server different from the authentication server 10 and so on. In addition, the information processing system may include various means (the authentication unit 204, the coupon management unit 303, and so on) as described in the above example embodiments.

In the above example embodiments, it is explained that the coupon that the tourism center sells is targeted for management. However, the coupon targeted by the information processing system may be a coupon issued by each store. Alternatively, the authentication server 10 may integrate and manage the coupon issued by the tourism center (a regional reconstruction coupon) and the coupon issued by each store (a store coupon). In other words, when the user makes a payment for purchasing a product by using the authentication terminal 30, both the store coupon issued by each store and the regional reconstruction coupon may be displayed so as to be selectable. The authentication terminal 30 may simultaneously apply discounts of the store coupon (for example, a coupon that offers a flat 10% discount off the price of a product) and the regional reconstruction coupon.

It is of course possible to combine the first example embodiment with the second example embodiment. In other words, the tourism center may sell both the electronic coupon and the paper coupon, and the user may choose which one to purchase. In this case, the information processing system may include the management server 20, and the authentication server 10 may include the ID verification unit 203 in the configuration shown in FIG. 19. When the authentication server 10 receives the authentication request from the authentication terminal 30, the authentication server 10 identifies the user by the biometric authentication. When the identified user has the paper coupon, the authentication server 10 transmits the coupon information transmission request, including the coupon ID of the paper coupon, to the management server 20. The management server 20 transmits to the authentication terminal 30 the owned coupon information, that combines the information on the electronic coupon and the information on the paper coupon of the user. The authentication terminal 30 and the authentication server 10 may transmit and receive the information related to the use of the paper coupon via the management server 20. When combining the first example embodiment and the second example embodiment, the registration destination of the paper coupon may be changed from the authentication server 10 to the management server 20. In this case, the terminal 40 transmits the coupon registration request to the management server 20. The management server 20 only needs to include the coupon registration unit 206 described in the second example embodiment.

The above example embodiments describe a case in which the paper coupon is registered by using the terminal 40. However, the registration of the paper coupon may be performed at the authentication terminal 30 installed at each store. Alternatively, the terminal 40 may acquire information of the store where the authentication terminal 30 (kiosk terminal) for the coupon registration is located from the authentication server 10.

The authentication server 10 or the authentication terminal 30 may make recommendations related to subsequent actions to the user who uses the coupon. For example, the authentication server 10 may present the user with information about other stores that are included in the area where the used coupon is available, and encourage the user to visit those stores. Alternatively, the authentication server 10 or the authentication terminal 30 may notify the user of information (for example, an address and contact information) related to other stores where a coupon owned by the user can be used.

The authentication server 10 may verify the identity of the user at the time of user registration. Specifically, the authentication server acquires from the terminal 40 an identity verification document (a document containing biometric information; for example, a passport) in addition to the biometric information of the user. The authentication server 10 determines that the verification of the identity of the user is successful when a one-to-one matching using the acquired biometric information and the biometric information acquired from the identity verification documents is successful. The authentication server 10 may register the biometric information of the applicant for registration when the verification of the identity is successful.

The authentication server 10 may acquire personal information of the user (for example, name, date of birth, gender, contact information, and so on) at the time of the user registration and store the personal information of the user in association with the biometric information. The authentication server 10 may use the acquired personal information to improve the service. For example, the authentication server 10 may use the acquired personal information to make a recommendation (recommend) related to a behavior of the user after using the coupon. At that time, the authentication server 10 may change contents to be recommended using the use coupon information and the personal information of the user. For example, the authentication server 10 may change the store to be recommended in accordance with the gender and age of the user, even when the coupon with the same available area is used.

Alternatively, when the user's schedule information, hotel reservation information, or lodging information can be acquired from an external server, the authentication server 10 may make a recommendation related to the behavior of the user after the coupon is used based on this information. For example, the authentication server understand the user's accommodation schedule and return schedule based on the reservation information, and may make a recommendation in accordance with the situation of the user. In addition, the authentication server 10 may make a recommendation that encourages the user to make a tour of tourist spots.

In the above example embodiments, after the user selects the coupon to be used, the management server 20 or the authentication server checks the validity of the selected coupon. However, when transmitting owned coupon information to the authentication terminal 30, the management server 20 or the authentication server 10 may select the valid coupon and transmit the information.

Alternatively, the determination related to the validity of the coupon may be performed by the authentication terminal 30 instead of the management server 20 or the authentication server 10. The authentication terminal 30 may verify the validity of the coupon selected by the user in accordance with the location where the device is located and the date and time.

Either the authentication server 10, the management server 20, or the authentication terminal 30 may recommend a coupon to be used when the user owns a plurality of coupons that can be used. For example, the authentication server 10 and so on may output a message prompting the user to use a coupon whose expiration date is nearing.

The above example embodiments describe the case where the biometric information related to the “face image” is transmitted from the authentication terminal 30 to the authentication server 10. However, the biometric information related to the “a feature value generated from the face image” may be transmitted from the authentication terminal 30 to the authentication server 10. In this case, the authentication server is able to omit the process of generating the feature value.

While the data transmitted and received between each apparatus (the authentication server apparatus 10, the management server 20, the authentication terminal 30, and the terminal 40) is not limited to any particular mode, the data transmitted and received between these apparatuses may be encrypted. The biometric information is transmitted and received between these apparatuses, and in order to properly protect the biometric information, it is desirable that the encrypted data is transmitted and received.

The variation 1 according to the above example embodiment 2 describes that the user is able to select the registration (the activation) of the paper coupon. However, not only a paper coupon but also an electronic coupon may be subject to the registration. In this case, the terminal 40 retains the information of the purchased electronic coupon and displays a GUI conforming to FIG. 25 in accordance with the operation of the user. For example, the terminal 40 displays an unregistered electronic coupon instead of “coupon A” in FIG. 25. The terminal 40 transmits a coupon registration request for the electronic coupon to the management server 20. The management server 20 handles the activated coupon as the coupon owned by the user.

The variation 2 according to the above example embodiment 2 describes a case in which the authentication server 10 analyzes the paper coupon image and acquires the serial number. However, the serial number may be entered into the authentication server 10 by the user. For example, when registering the paper coupon, the terminal 40 displays a GUI for entering the serial number and transmits the acquired serial number to the authentication server 10.

In the flowcharts and sequence diagrams used in the above description, a plurality of steps (processes) are sequentially described. However, the order of the execution of the steps performed in the individual example embodiment is not limited to the described order. In the individual example embodiment, the order of the illustrated steps may be changed to the extent that a problem is not caused on the content of the individual example embodiment. For example, individual processes may be executed in parallel.

The above example embodiments have been described in detail to facilitate the understanding of the present application disclosed and not to mean that all the configurations described above are needed. In addition, if a plurality of example embodiments have been described, each of the example embodiments may be used individually or a plurality of example embodiments may be used in combination. For example, part of a configuration according to one example embodiment may be replaced by a configuration according to another example embodiment. For example, a configuration according to one example embodiment may be added to a configuration according to another example embodiment. In addition, addition, deletion, or replacement is possible between part of a configuration according to one example embodiment and another configuration.

The industrial applicability of the present invention has been made apparent by the above description. That is, the present invention is suitably applicable, for example, to information processing systems and so on that handle coupons that can be used at retail stores.

A part or the entirety of the example embodiments described above may be described as in the following supplementary notes, but is not limited to the followings.

### [Supplementary Note 1]

A system, including:
an authentication server that stores biometric information and a user ID of each of a plurality of users in association with each other;
a management server, the management server being connected to the authentication server, that stores the user ID of each of the plurality of users and information of at least one or more electronic coupons owned by each user in association with each other; and
an authentication terminal that is connected to the authentication server and the management server,
wherein the authentication terminal transmits an authentication request including biometric information of a first user who uses the electronic coupon among the plurality of users to the authentication server,
wherein the authentication server identifies a first user ID corresponding to the first user by a biometric authentication using the biometric information included in the authentication request, and transmits a coupon information transmission instruction including the identified first user ID to the management server, and
wherein the management server transmits owned coupon information related to the electronic coupon owned by the first user corresponding to the first user ID included in the coupon information transmission instruction to the authentication terminal.

### [Supplementary Note 2]

The system according to supplementary note 1, wherein the authentication terminal displays a GUI (Graphical User Interface) for selecting the electronic coupon that the first user wishes to use by using the owned coupon information.

### [Supplementary Note 3]

The system according to supplementary note 2, wherein the authentication terminal transmits to the management server use coupon information related to the electronic coupon that the first user wishes to use.

### [Supplementary Note 4]

The system according to supplementary note 3, wherein the management server verifies a validity of the electronic coupon, the electric coupon being notified by the use coupon information, that the first user wishes to use.

### [Supplementary Note 5]

The system according to supplementary note 4, wherein the management server deletes the electronic coupon whose validity is verified.

### [Supplementary Note 6]

The system according to any one of supplementary notes 1 to 5, wherein the authentication server stores the biometric information of each of the plurality of users and information of at least one or more paper coupons owned by each user in association with each other,
wherein the authentication terminal transmits an authentication request including the biometric information of a second user who uses the paper coupon among the plurality of users to the authentication server, and
wherein the authentication server identifies the second user by the biometric authentication using the biometric information included in the authentication request, and transmits the owned coupon information related to the paper coupon owned by the identified second user to the authentication terminal.

### [Supplementary Note 7]

The system according to supplementary note 6, further including:
a terminal transmits a coupon registration request to the authentication server that includes biometric information of the second user and a paper coupon image that is photographed the paper coupon purchased by the second user, and
wherein the authentication server identifies the second user by the biometric authentication using the biometric information included in the coupon registration request, and stores the identified user and information of the paper coupon acquired from the paper coupon image in association with each other.

### [Supplementary Note 8]

The system according to supplementary note 7, wherein the terminal displays a GUI (Graphical User Interface) for acquiring the biometric information of the second user and the paper coupon image.

### [Supplementary Note 9]

The system according to supplementary note 8, wherein the terminal displays a registered paper coupon in the authentication server and an unregistered paper coupon in the authentication server while distinguishing the registered paper coupon and the unregistered paper coupon from each other and displays a GUI (Graphical User Interface) including a button for registering the unregistered paper coupon.

### [Supplementary Note 10]

The system according to supplementary note 9, wherein the terminal acquires the biometric information of the second user when the button is pressed.

[Supplementary Note 11]

The system according to any one of supplementary notes 1 to 10, wherein the biometric information is a face image or a feature value generated from the face image.

### [Supplementary Note 12]

An authentication server including:
a database that stores biometric information and a user ID of each of a plurality of users in association with each other;
a receiving unit that receives an authentication request including biometric information of a first user who uses an electronic coupon among the plurality of users from an authentication terminal;
an authentication unit that identifies a first user ID corresponding to the first user by biometric authentication using biometric information included in the authentication request; and
a transmission unit that transmits a coupon information transmission instruction including the identified first user ID to a management server that stores the user ID of each of the plurality of users and information of at least one or more electronic coupons owned by each user in association with each other.

### [Supplementary Note 13]

A management server including:
a database that stores a user ID of each of a plurality of users and information of at least one or more electronic coupons owned by each user in association with each other;
a receiving unit that receives a coupon information transmission instruction from an authentication server that stores biometric information and the user ID of each of the plurality of the users in association with each other, receives an authentication request including the biometric information of a first user who uses the electronic coupon among the plurality of users from an authentication terminal, identifies a first user ID corresponding to the first user by the biometric authentication by using the biometric information included in the authentication request, and transmits the coupon information transmission request including the identified first user ID; and
a transmission unit that transmits owned coupon information related to the electronic coupon that is owned by the first user corresponding to the first user ID included in the coupon information transmission instruction to the authentication terminal.

### [Supplementary Note 14]

An authentication terminal including:
a transmission unit that transmits an authentication request including biometric information of a first user who uses an electronic coupon among a plurality of users to an authentication server that stores biometric information and a user ID of each of the plurality of users in association with each other; and
a receiving unit that receives owned coupon information related to an electronic coupon owned by the first user corresponding to a first user ID included in a coupon information transmission instruction from a management server that stores the user ID of each of the plurality of users and information of at least one or more electronic coupons owned by each user in association with each other, and receives a coupon information transmission instruction including the first user ID corresponding to the first user from the authentication server.

### [Supplementary Note 15]

A method performed in a system, the system including:
an authentication server that stores biometric information and a user ID of each of a plurality of users in association with each other;
a management server, being connected to the authentication server, that stores the user ID of each of the plurality of users and information of at least one or more electronic coupons owned by each user in association with each other; and
an authentication terminal that is connected to the authentication server and the management server;
wherein the method including:
transmitting an authentication request including biometric information of a first user who uses the electronic coupon among the plurality of users to the authentication server;
identifying a first user ID corresponding to the first user by the biometric authentication using the biometric information included in the authentication request and transmitting a coupon information transmission instruction including the identified first user ID to the management server; and
transmitting owned coupon information related to the electronic coupon owned by the first user corresponding to the first user ID included in the coupon information transmission instruction to the authentication terminal.

The entire disclosure of the above patent literature is incorporated herein by reference thereto. While the example embodiments of the present invention have thus been described, the present invention is not limited to these example embodiments. It is to be understood to those skilled in the art that these example embodiments are only examples and that various variations are possible without departing from the scope and sprit of the present invention. That is, the present invention of course includes various variations and modifications that could be made by those skilled in the art in accordance with the overall disclosure including the claims and the technical concept.

### REFERENCE SIGNS LIST

10, 101 authentication server
20, 102 management server
30, 103 authentication terminal
40 terminal
201, 301, 401, 501 communication control unit
202 user registration unit
203 ID verification unit
204 authentication unit
205, 304, 403, 504 storage unit
206 coupon registration unit
207, 303 coupon management unit
302 coupon sales unit
311 processor
312 memory
313 input-output interface
314 communication interface
402 coupon usage unit
502 user registration request unit
503 coupon purchase unit
505 coupon registration request unit

What is claimed is:

1. A system, comprising:
an authentication server that stores biometric information and a user ID of each of a plurality of users in association with each other;
a management server, the management server being connected to the authentication server, that stores the user ID of each of the plurality of users and information of at least one or more electronic coupons owned by each user in association with each other; and
an authentication terminal that is connected to the authentication server and the management server,
wherein the authentication terminal transmits an authentication request including biometric information of a first user who uses the electronic coupon among the plurality of users to the authentication server,
wherein the authentication server identifies a first user ID corresponding to the first user by a biometric authentication using the biometric information included in the authentication request, and transmits a coupon information transmission instruction including the identified first user ID to the management server, and
wherein the management server transmits owned coupon information related to the electronic coupon owned by the first user corresponding to the first user ID included in the coupon information transmission instruction to the authentication terminal.

2. The system according to claim 1, wherein the authentication terminal displays a GUI (Graphical User Interface) for selecting the electronic coupon that the first user wishes to use by using the owned coupon information.

3. The system according to claim 2, wherein the authentication terminal transmits to the management server use coupon information related to the electronic coupon that the first user wishes to use.

4. The system according to claim 3, wherein the management server verifies a validity of the electronic coupon, the electric coupon being notified by the use coupon information, that the first user wishes to use.

5. The system according to claim 4, wherein the management server deletes the electronic coupon whose validity is verified.

6. The system according to claim 1, wherein the authentication server stores the biometric information of each of the plurality of users and information of at least one or more paper coupons owned by each user in association with each other,
wherein the authentication terminal transmits an authentication request including the biometric information of a second user who uses the paper coupon among the plurality of users to the authentication server, and
wherein the authentication server identifies the second user by the biometric authentication using the biometric information included in the authentication request, and transmits the owned coupon information related to the paper coupon owned by the identified second user to the authentication terminal.

7. The system according to claim 6, further comprising:
a terminal transmits a coupon registration request to the authentication server that includes biometric information of the second user and a paper coupon image that is photographed the paper coupon purchased by the second user, and
wherein the authentication server identifies the second user by the biometric authentication using the biometric information included in the coupon registration request, and stores the identified user and information of the paper coupon acquired from the paper coupon image in association with each other.

8. The system according to claim 7, wherein the terminal displays a GUI (Graphical User Interface) for acquiring the biometric information of the second user and the paper coupon image.

9. The system according to claim 8, wherein the terminal displays a registered paper coupon in the authentication server and an unregistered paper coupon in the authentication server while distinguishing the registered paper coupon and the unregistered paper coupon from each other and displays a GUI (Graphical User Interface) including a button for registering the unregistered paper coupon.

10. The system according to claim 9, wherein the terminal acquires the biometric information of the second user when the button is pressed.

11. The system according to claim 1, wherein the biometric information is a face image or a feature value generated from the face image.

12. An authentication server comprising:
a database that stores biometric information and a user ID of each of a plurality of users in association with each other;
at least one memory storing a set of instructions; and
at least one processor configured to execute the set of instructions to:
receive an authentication request including biometric information of a first user who uses an electronic coupon among the plurality of users from an authentication terminal;
identify a first user ID corresponding to the first user by biometric authentication using biometric information included in the authentication request; and
transmit a coupon information transmission instruction including the identified first user ID to a management server that stores the user ID of each of the plurality of users and information of at least one or more electronic coupons owned by each user in association with each other.

13. A management server comprising:
a database that stores a user ID of each of a plurality of users and information of at least one or more electronic coupons owned by each user in association with each other;
at least one memory storing a set of instructions; and
at least one processor configured to execute the set of instructions to:
receive a coupon information transmission instruction from an authentication server that stores biometric information and the user ID of each of the plurality of the users in association with each other, receives an authentication request including the biometric information of a first user who uses the electronic coupon among the plurality of users from an authentication terminal, identifies a first user ID corresponding to the first user by the biometric authentication by using the biometric information included in the authentication request, and transmits the coupon information transmission request including the identified first user ID; and
transmit owned coupon information related to the electronic coupon that is owned by the first user corresponding to the first user ID included in the coupon information transmission instruction to the authentication terminal.

14. (canceled)

15. (canceled)
